(19) United States
(12) Patent Application Publication
(10) Pub. No.: US 2024/0217624 A1
(43) Pub. Date: Jul. 4, 2024

(54) MOORING COMPONENT AND SYSTEM

(71) Applicant: TECHNOLOGY FROM IDEAS LIMITED, Dun Laoghaire, Co Dublin (IE)

(72) Inventors: Paul McEvoy, Dun Laoghaire, Co Dublin (IE); Conor Casey, Dun Laoghaire, Co Dublin (IE); Osayomwanbor Ehiegharevba, Dun Laoghaire, Co Dublin (IE); Reinaldo Pereira, Dun Laoghaire, Co Dublin (IE)

(21) Appl. No.: 18/557,423

(22) PCT Filed: Apr. 26, 2022
(86) PCT No.: PCT/EP2022/061099

§ 371 Date: Oct. 26, 2023

(30) Foreign Application Priority Data
Apr. 27, 2021 (GB) 2105965.4

(51) Int. Cl. B63B 21/50; B63B 21/00; B63B 21/20

(52) U.S. Cl. CPC B63B 21/50; B63B 21/20; B63B 2021/005; B63B 2021/203

(57) ABSTRACT

A mooring system includes a first mooring component and a second mooring component. The first mooring component includes a first end plate, a second end plate, and a first compressive element, connected between the first and second end plates. The second mooring component, includes a third end plate, a fourth end plate, and a second compressive element, connected between the third and fourth end plates. The mooring system further includes a flexible connecting element, including first and second lengths. The first and second lengths are connected to the first and fourth end plates, and pass through openings in the second and third end plates, such that the first mooring component and the second mooring component are connected in series.

### BACKGROUND OF THE INVENTION

This invention relates to a mooring component and a system comprising mooring components, in particular for mooring a floating structure in a body of water.

Floating marine structures, such as floating offshore wind turbines, may use a mooring system connected between the seabed and the floating marine structure to keep the structure in place. Typically such a mooring system will be designed so that any motion of the floating structure away from its desired position is resisted, and a restoring force is generated, to return the structure to the desired position.

A range of different mooring system types exists, such as catenary, taut and semi-taut. All of these can use a range of mooring components such as chains, synthetic ropes, clump weights, anchors and floats, which together define the response of that mooring system to changes in the position of the floating structure.

However, these mooring systems are not particularly suitable for the mooring of certain floating marine structures, including floating offshore wind turbines or tidal turbines, in which the mooring lines experience a high average background thrust load due to the operation of the turbine, in addition to the dynamic loads (i.e. the force experienced by the mooring system before dynamic loads are applied, such as that which is applied by the mean wind or current).

With a background thrust, the structure will move to a new position (away from the direction of the background thrust) until the restoring force of the mooring system (i.e. the restoring force which returns a structure to its desired position and increases the further it moves from that position) matches the background thrust. A high background thrust therefore results in a high restoring force from the mooring system.

Under these conditions the stiffness of the mooring system (i.e. the force required to move the floating structure any further) is typically very high, as most mooring systems become progressively stiffer the further the floating structure moves from the desired location. When dynamic forces (i.e. waves) move the floating structure around its new position, the high stiffness results in very high variable loads (i.e. a small change in position results in a high change in tension) on the mooring system. These high variable loads can result in a high design load for the mooring line (i.e. the maximum load which the mooring line needs to survive without breaking), therefore requiring larger and more expensive mooring components. These high variable loads also result in much higher fatigue on the mooring line components, which also requires more expensive mooring components as well as more frequent inspections or component replacement.

The compliance of these typical mooring systems is primarily used up by the background thrust load, leaving very little compliance left to manage the dynamic loads.

It is therefore desirable to provide a mooring component and a mooring system which provide a desirable stiffness response, whose compliance is tailored to where it is needed, namely at or above the thrust load. Such a system would result in lower variable loads, reducing the cost of the mooring, which is advantageous since such a mooring system also needs to be cost competitive compared to existing mooring solutions.

### SUMMARY OF THE INVENTION

From a first aspect, the invention provides a mooring system, comprising:
a first mooring component, the first mooring component comprising:
   a first end plate;
   a second end plate; and
   a first compressive element, connected between the first end plate and the second end plate;
a second mooring component, the second mooring component comprising:
   a third end plate;
   a fourth end plate; and
   a second compressive element, connected between the third end plate and the fourth end plate; and
a flexible connecting element, comprising a first length, connected to the first end plate at a first position, and to the fourth end plate at a second position, and passing through openings in the second end plate and the third end plate, and comprising a second length, connected to the first end plate at a third position, and to the fourth end plate at a fourth position, and passing through openings in the second end plate and the third end plate, such that the first mooring component and the second mooring component are connected in series.

Thus, there is provided a first mooring component and a second mooring component, arranged adjacent to each other, in series, and connected by a flexible connecting element to form a mooring system. It will be understood that in this arrangement the second end plate (which is an end plate of the first mooring component) and the third end plate (which is an end plate of the second mooring component) are arranged adjacent to each other, with respect to an axis along the length of the mooring component.

Since two separate, individual mooring components are provided, the compressive elements of each mooring component are separately connected between a respective pair of plates. This allows each mooring component to be held individually by its respective plates, improving stability of the compressive element under compression. Furthermore, providing a mooring system which comprises at least two such mooring components advantageously allows the number and arrangement of these mooring components to be selected for specific situations, as required. For example the number of mooring components in a mooring system may be selected based on the total maximum load which that mooring system (or mooring line) may be required to withstand.

The response achievable with such a modular mooring system is more versatile and adaptable than a mooring system using larger, or combined, mooring components. This is particularly the case where the compressive element is a single convolute, as discussed below, in comparison to a single mooring component comprising multiple convolutes between its end plates.

By providing a flexible connecting element, connected at two positions to an end plate of a first mooring component and at two positions to an end plate of a second mooring component, a strong and reliable connection is provided which allows compression of the respective compressive elements, whilst responding advantageously to various forces due to its flexibility, e.g. by allowing relative movement/bending of the connection between the first mooring component and the second mooring component. Higher yield strength materials (e.g. forged chain links) can be used in such flexible connecting elements, which are typically smaller and lighter than equivalent components, e.g. machined steel beams, which are required for rigid connecting elements.

Furthermore the provision of a single connecting element (albeit comprising multiple lengths) passing all the way through two mooring components and connecting them together provides a means which both compresses each of the mooring components and connects them together. This provides a more lightweight mooring system since fewer components are required.

It will be understood that by a flexible connecting element it is meant that the connecting element is non-rigid, e.g. able to bend or flex. Such a flexible element could be made of a flexible material, e.g. rope or fibre link, or could be made of a rigid material, e.g. metal, formed into a flexible structure, e.g. chain links or loops.

The flexible connecting element comprises a first length and a second length. It will be understood that these lengths may be entirely separate, they may cross over with or without contacting, they may intersect or interconnect, e.g. be attached to a common structure, e.g. link, ring or plate, or directly attach to each other, or they may overlap or be coincident, i.e. share a common length or section.

Thus, in some embodiments the first length and the second length meet at a first intersection point, i.e. the individual lengths of the first connecting element may be brought together into a single connection point between the first end plate and the fourth end plate. The presence of an intersection point in the first connecting element helps to improve the flexibility of the mooring system by providing a pivot point about which the mooring system is able to flex. It will be understood that in such embodiments the first position may be opposite to the fourth position (i.e. positioned along the same axis, parallel to the mooring system axis), and likewise the third position will be opposite to the second position. In other words, the first and fourth position may respectively correspond, and the second and third position may respectively correspond. In contrast, in embodiments in which the first length and the second length do not meet (within the mooring system), the first position may be opposite the second position and the third position may be opposite the fourth position, i.e. the lengths are parallel.

In some embodiments, the first position, the second position, and the first intersection point define a first plane.

In some embodiments the first length and the second length are angled (i.e. non-parallel) relative to one another. A central axis may be defined for the mooring component or system. It will be understood the central axis may be a central axis of a mooring component, e.g. an axis which is central with respect to the cross-section of the end plates or compressive element of the mooring component, and perpendicular to such a cross-section. For example, the compressive element may have a substantially circular cross section with respect (i.e. perpendicular) to an element axis (which may be the central axis of the mooring component/system). Additionally, or alternatively, the central axis may be the central axis of a mooring system, i.e. an elongate axis along which the mooring components of the mooring system are arranged. The first length and the second length may be angled with respect to the central axis.

Where not otherwise stated, the positions of the various elements refers to their configuration when the connecting element is under tension, e.g. pulled taught, such that the compressive elements are under compression (although they may not be deformed).

The first connecting element is connected to, e.g. terminates at, the first end plate (which is an end plate of the first mooring component) and the fourth end plate (which is an end plate of the second mooring component). This mooring system may then be connected within a larger mooring system/arrangement by connecting a second connecting element to the second end plate, and a third connecting element to the third end plate. If these second and third connecting elements are actuated respectively away from each other, the first and second mooring components are moved away from each other. However, this movement is resisted by the first connecting element, which prevents the first end plate and the fourth end plate from moving away from each other. This therefore results in compression of the first and second compressive elements.

Thus, in some embodiments, the mooring system comprises a second connecting element, connected to the second end plate and/or a third connecting element, connected to the third end plate. In some embodiments the mooring component is arranged such that actuation of the first flexible connecting element and the second connecting element, respectively away from each other, results in compression of the first compressive element. Similarly, in some embodiments the mooring component is arranged such that actuation of the first flexible connecting element and the third connecting element, respectively away from each other, results in compression of the second compressive element. The second connecting element may pass through an opening in the first end plate. The third connecting element may pass through an opening in the fourth end plate. The second connecting element and/or the third connecting element may be flexible.

In some embodiments the mooring system further comprising a second connecting element, comprising a third length, connected to the second end plate at a fifth position, and a fourth length, connected to the second end plate at a sixth position, wherein the third length and the fourth length meet at a second intersection point. In some embodiments the fifth position, the sixth position and the second intersection point define a second plane.

In some embodiments the mooring system further comprising a third flexible connecting element, comprising a fifth length, connected to the third end plate at a seventh position, and a sixth length, connected to the third end plate at an eighth position, wherein the fifth length and the sixth length meet at a third intersection point. The seventh position, the eighth position and the third intersection point may define a third plane. The features described herein below in relation to the second connecting element and second plane may apply additionally, or alternatively, to the third connecting element and the third plane.

As discussed above, a further (flexible) connecting element may similarly be connected to the third end plate. The distal ends of these other connecting elements (i.e. the ends which are not attached to the respective plates) provide connections to which additional mooring components, or alternatively other mooring lines, may be connected. This provides a mooring system in which the compressive elements can be put under compression by actuating the first and second connecting elements, mutually away from each other, providing extension to a mooring line within which the mooring system is attached/positioned. The flexibility of the connecting elements makes the mooring system more suitable for incorporation within a flexible mooring line e.g. since it can be more conveniently transported, handled and deployed (since it is made up of several individual components), and can flex with the rest of the mooring line e.g. due to changes in the catenary shape of the mooring line, at least when the mooring line is under relatively low tension.

The additional second and/or third connecting elements discussed above can be used not only to actuate compression of the mooring components of the system, but could alternatively be used to connect further mooring components into the series. In such embodiments, the “internal” connecting elements, which connect between two adjacent mooring components, will not be used directly to actuate compression of the mooring components but rather the whole chain will be compressed by actuation of only the connecting elements arranged at either end of the series—the “external” connecting elements. For example, considering a mooring system comprising three mooring components, the first, and third connecting elements discussed above will connect between adjacent mooring components, i.e. the first and second components, and the second and third components, respectively. However, the first mooring component (i.e. the component at a first end of the series) will include the second connecting element connected to the second end plate, passing through the first end plate, which will be accessible for actuation. Similarly, the third mooring component (i.e. the component at the other end of the series) will comprise a fourth connecting element, which will pass through the end plate of the third mooring component, and be accessible for actuation e.g. be external to the system.

Thus, in some embodiments, the mooring system comprises a series (e.g. three or more) of mooring components, each mooring component comprising:
a first end plate;
a second end plate; and
a compressive element, connected between the first end plate and the second end plate;
wherein the first end plate of one component is connected to the second end plate of the next component in the series by a respective connecting element,
comprising a first length, connected to the first end plate at a first position, and to the second end plate at a second position, and passing through openings in the second end plate of one component and the first end plate of the next component; and
comprising a second length, connected to the first end plate at a third position, and to the second end plate at a fourth position, and passing through openings in the second end plate of one component and the first end plate of the next component.

As referred to above, the mooring system may be included within a mooring line. Thus, in some embodiments, the mooring system further comprises a mooring line, wherein the second end plate of the first component in the series is connected to the mooring line, by a first mooring line connecting element, passing through the first end plate of the first component, and wherein the first end plate of the last component in the series is connected to the mooring line, by a second mooring line connecting element, passing through the second end plate of the last component.

In some embodiments the first plane and the second plane are non-parallel (i.e. the plane containing the first connecting element is rotated relative to the plane containing the second and/or third connecting element e.g. rotated relative to the central axis of the mooring component/system). This increases the stability of the mooring system (e.g. against twisting/rotation), by ensuring that tension force applied along the connecting elements is not transferred along a single plane, and furthermore helps to avoid any interaction or clashing between the various connecting elements.

The arrangement of connecting elements, defining non-parallel planes, is considered to be both novel and inventive in its own right, and therefore, from a second aspect, the invention provides a mooring component, comprising:
a first end plate comprising an opening;
a second end plate comprising an opening;
a compressive element, connected between the first end plate and the second end plate;
a first connecting element, which passes through the opening in the second end plate, wherein the first connecting element comprises a first length, connected to the first end plate at a first position, and a second length, connected to the first end plate at a second position, the first length and the second length meeting at a first intersection point, such that the first position, the second position and the first intersection point define a first plane; and
a second connecting element which passes through the opening in the first end plate, wherein the second connecting element comprises a third length, connected to the second end plate at a third position, and a fourth length, connected to the second end plate at a fourth position, the third length and the fourth length meeting at a second intersection point, such that the third position, the fourth position and the second intersection point define a second plane;
wherein the first plane and the second plane are non-parallel; and
wherein the mooring component is arranged such that actuation of the first connecting element and the second connecting element, respectively away from each other, results in compression of the compressive element.

It will be appreciated that the preferred and optional features outlined with respect to the other aspects of the invention apply equally to this aspect, as appropriate.

By providing connecting elements which each connect to their respective plates at two positions, a stable arrangement which allows compression of the compressive element is provided. Furthermore, the connecting elements can be used for connecting the mooring component to onwards components e.g. connecting into a mooring line/chain, or to further mooring components. The connecting elements thus provide both a compression means and a connecting means, and do so in a manner which is lighter weight than known connecting and/or compressing means.

The first connecting element comprises a first length and a second length. It will be understood that these lengths may be entirely separate, they may cross over with or without contacting, they may intersect or interconnect, e.g. be attached to a common structure, e.g. link, ring or plate, or directly attach to each other, or they may overlap or be coincident i.e. share a common length or section. This is also true of the third and fourth lengths of the second connecting element.

The first intersection point and/or the second intersection point may be within the first compressive element. Alternatively, the first intersection point and/or the second intersection point may be outside of the first compressive element. Thus, in embodiments comprising two mooring components, the first intersection point (and/or the second mooring component) may be between the first mooring component and the second mooring component, i.e. between the first and second compressive elements.

In some embodiments, the first intersection point is closer than the second intersection point to the second end plate. Thus in some embodiments, the second intersection point is closer than the first intersection point to the first end plate. This helps to improve the stability of the mooring system when the connecting elements are put under tension.

In some embodiments, the first intersection point and the second intersection point may be positioned on a common axis which passes through both intersection points. The common axis may be the central axis of the mooring component, or the mooring system, e.g. the axis passing through the centre of the end plates and/or the compressive element. It will be understood that in such an embodiment the positions of the intersection points will be such that the first connecting element and the second connecting element are interleaved, e.g. the connecting elements each define a V-shape between the respective end plate and the intersection point, wherein the V-shapes are inverted with respect to each other, and overlap along the elongate axis of the mooring system. The apices (or apexes, or intersection points) of the respective V (or Y) shapes, need not (and in fact preferably do not) contact each other in this interleaved position. In other words, the first and second connecting elements may be overlapped along the central axis, for at least part of their length, but are preferably spaced sufficiently far apart, along the central axis, that even at the extremes of compression of the compressive element there is no contact between the first connecting element and the second connecting element.

In some embodiments, the line of intersection of the first plane and the second plane is coincident with the central axis of the mooring component. This helps to improve stability of the mooring system under tension, since force is transferred along the central, e.g. symmetrical, axis of the mooring component. It also helps mooring system to have a lower torsional stiffness along the central axis, and a lower bending stiffness. These properties can be advantageous in certain circumstances.

In some embodiments, the first plane and the second plane are mutually perpendicular. Thus the first connecting element and the second connecting element are arranged at right angles (90°) to one another. This gives particularly good stability for an arrangement in which two connection points for the connecting element are used. Where additional connecting elements are present, the angle between the planes defined by each may preferably be equal, e.g. three planes, at 60° to each other.

In some embodiments, the first (and/or second) connecting element may comprise at least one additional length, i.e. in addition to the first length and the second length. This additional length may lie outside of the respective plane defined by the first length and the second length, i.e. such that overall the first (and/or second) connecting element defines a coordinate system rather than a plane. The coordinate systems of two such connecting elements may be rotated with respect to each other (e.g. by 60 degrees for three lines).

In some embodiments, the first length and the second length comprise at least one common connection point, e.g. ring or link, in common between the first length and the second length. Thus the common connection may define the intersection point of the first connecting element. The first length and the second length may additionally comprise a common length, attached to the common connection point, e.g. giving a Y-shaped connecting element, where each “branch” of the Y belongs respectively to the first length and the second length, and the lower part is common to both the first and second length. This shape provides a convenient connection point to which another connecting element of another mooring component, or a mooring line, can be attached.

According to a third aspect, there is provided a mooring system comprising at least two mooring components as described herein above, wherein the mooring components are connected in series. It will be appreciated that the preferred and optional features outlined with respect to the other aspects of the invention apply equally to this aspect, as appropriate.

In some embodiments, the first connecting element of a first mooring component comprises at least one ring or link in common with a second connecting element of a second mooring component. This allows one mooring component to be conveniently attached to an adjacent mooring component, whilst requiring minimal additional components. In some embodiments the at least one ring or link may be a forged link, and the first length and/or the second length may be provided by forged chain. In such embodiments the first connecting element can advantageously be manufactured as a single forged assembly, so that the first length and the second length cannot be detached from the link.

In some embodiments according to the second and third aspects of the present invention, the first connecting element (optionally each connecting element, e.g. also the second connecting element/third connecting element) is rigid. Optionally, the first connecting element may be (substantially) Y-shaped. This helps to provide a strong, stable connecting element, which can be formed as a single piece.

In other embodiments according to the second and third aspects of the present invention, the first connecting element (optionally each connecting element e.g. also the second connecting element/third connecting element) is flexible. It will be understood that by a flexible connecting element it is meant that the element is non-rigid, e.g. able to bend or flex. Such a flexible element could be made of a flexible material e.g. rope, or could be made of a rigid material e.g. metal, formed into a flexible structure, e.g. chain links, or loops. This is advantageous since when a series of such mooring components are connected together it allows their interconnections, provided by the connecting elements, to flex and bend, improving the response of such a mooring system.

A non-intersecting arrangement of connecting elements can also be provided, e.g. as an alternative to the second aspect, which also achieves the effect of providing an improved mooring system. Thus, according to a fourth aspect, the invention provides a mooring system, comprising:
a first mooring component, the first mooring component comprising:
   a first end plate;
   a second end plate; and
   a first compressive element, connected between the first end plate and the second end plate;
a second mooring component, the second mooring component comprising:
   a third end plate;
   a fourth end plate; and
   a second compressive element, connected between the third end plate and the fourth end plate; and
a first connecting element, comprising a first length, connected to the first end plate at a first position, and to the fourth end plate at a second position, and passing through openings in the second end plate and the third end plate, and the first connecting element comprising a separate second length, connected to the first end plate at a third position, and to the fourth end plate at a fourth position, and passing through openings in the second end plate and the third end plate, such that the first mooring component and the second mooring component are connected in series.

It will be appreciated that the preferred and optional features outlined with respect to the other aspects of the invention apply equally to this aspect, as appropriate.

By connecting adjacent mooring components in series using two separate lengths of a connecting element, a mooring system is provided which allows the compressive elements to be mutually compressed by applying tension to the connecting elements. The absence of any connection or intersection between the connecting elements (e.g. owing to them being spaced from each other) avoids any risk of wear or damage due to contact between these components and reduces the amount of components required. Moreover, the claimed arrangement provides a stable and reliable way of connecting multiple mooring components together in series, since it provides multiple points of connection to each mooring component, and is arranged so that force e.g. tension applied to the mooring system is not transferred through the various mooring components along a single line. The described connecting element, comprising two separate lengths, is more lightweight than known connection and/or compression means.

In some embodiments, the mooring system further comprises a second connecting element, comprising a third length, connected to the second end plate at a fifth position, and a fourth length, connected to the second end plate at a sixth position wherein the mooring system is arranged such that actuation of the first and second connecting elements, respectively away from each other, results in compression of the first compressive element. The third length and the fourth length may meet or intersect, outside of the first mooring component, e.g. to form a single point of connection to which a mooring line or chain might be connected.

There may similarly (or alternatively) be an additional connecting element attached to the third end plate, enabling compression of the second compressive element. Thus, in some embodiments, the mooring system further comprises a third connecting element, comprising a fifth length, connected to the third end plate at a seventh position, and a sixth length, connected to the third end plate at an eighth position wherein the mooring system is arranged such that actuation of the first and third connecting elements, respectively away from each other, results in compression of the second compressive element. The fifth length and the sixth length may meet or intersect, outside of the second mooring component, e.g. to form a single point of connection to which a mooring line or chain might be connected.

Thus, in some embodiments, the mooring system comprises a series (e.g. three or more) of mooring components, each mooring component comprising:
a first end plate;
a second end plate; and
a compressive element, connected between the first end plate and the second end plate;
wherein the first end plate of one component is connected to the second end plate of the next component in the series by a respective connecting element,
comprising a first length, connected to the first end plate at a first position, and to the second end plate at a second position, and passing through openings in the second end plate of one component and the first end plate of the next component; and
a separate second length, connected to the first end plate at a third position, and to the second end plate at a fourth position, and passing through openings in the second end plate of one component and the first end plate of the next component.

As referred to above, the mooring system may be included within a mooring line. Thus, in some embodiments, the mooring system further comprises a mooring line, wherein the second end plate of the first component in the series is connected to the mooring line, by a first mooring line connecting element, passing through the first end plate of the first component, and wherein the first end plate of the last component in the series is connected to the mooring line, by a second mooring line connecting element, passing through the second end plate of the last component.

It will be understood that although referred to as a first connecting “element” this element is actually provided by two separate lengths, i.e. lengths which do not meet or contact within the claimed mooring system. For example, the two separate lengths do not meet within either of the mooring components, or within the region in between the mooring components. The two lengths may be parallel to each other. It will further be understood that this does not exclude the possibility of such “separate” lengths meeting or joining at some point outside the claimed mooring system. For example, where a second connecting element is attached to the second end plate, the first length and second length of that second connecting element may be connected to each other, outside of the first mooring component, e.g. to form a single point to which a mooring line may be connected.

In some embodiments the first connecting element (optionally each connecting element, e.g. also the second connecting element/third connecting element) is rigid. Optionally, the first connecting element may be (substantially) Y-shaped. This helps to provide a strong, stable connecting element, which can be formed as a single piece.

In other embodiments the first connecting element (optionally each connecting element, e.g. also the second connecting element/third connecting element) is flexible. It will be understood that by a flexible connecting element it is meant that the element is non-rigid, e.g. able to bend or flex. Such a flexible element could be made of a flexible material, e.g. rope or fibre link, or could be made of a rigid material, e.g. metal, formed into a flexible structure e.g. chain links, or loops. This is advantageous since when a series of such mooring components are connected together it allows their interconnections, provided by the connecting elements, to flex and bend, improving the response of such a mooring system.

A number of features, as described herein below, may be present in any of the aspects described above. It will be appreciated that throughout, references made to a “first” compressive element, “first” connecting element, “first” end plate, etc. may apply equally to any or all other like components present in the claimed arrangement.

The connecting elements may be metal. They may be forged or cast.

In some embodiments, the first connecting element (and/or second connecting element etc.) comprises at least one chain link. Optionally the entire connecting element may comprise chain link. This provides a particularly convenient and easily available material for the connecting elements.

In some embodiments the first flexible connecting element comprises at least one ring. This provides a convenient point to which multiple length or connecting elements may be easily connected.

Some embodiments comprise a triangular plate (tri-plate) connected to the (first) connecting element, wherein the triangular plate comprises three connection points. This provides a convenient connection means, e.g. at an intersection point, which prevents contact between the various components connected to the plate.

In some embodiments the first connecting element is connected to the first end plate at the first position by shackles (and similarly for the other lengths/connecting elements, connected at other positions). These are convenient for connections and can also be easily fastened and undone if required.

In some embodiments, the first position (and/or the second position) on the first plate is provided by a protrusion from a surface of the first plate, optionally from an outer surface of the first end plate. The outer surface will be understood as the surface opposite to the surface of the first end plate which contacts the first compressive element. Alternatively, the first position (and/or the second position) on the first plate may be provided by a protrusion from an inner edge of an opening in the first plate (e.g. a protrusion from an inner circumference). This opening may be the same opening through which the connecting elements pass, or may be different. This may likewise be the case for any (or all) other end plates present in the mooring component/system and the positions at which they connect to respective connecting elements. The use of a protrusion to provide a connection position for a length of a connecting element is advantageous because it helps to ensure that the first length and second length do not interact with the compressive element or the intervening end plates which they respectively pass through, and it provides an arrangement which can be easily assembled, by providing easy access to the connection points and any pins/shackles which might be used to connect the first/second length.

In such embodiments, where the connection position is provided by a protrusion, the protrusion may comprise a first protrusion portion and a second protrusion portion, defining a gap therebetween configured to receive the connecting element, so as to form a connection with the end plate. In other words, the protrusion may be shaped or adapted to receive the connecting element. Alternatively, an end portion of the connecting element may be shaped or adapted to receive the protrusion, e.g. having two extending portions, providing a gap therebetween suitable to receive the protrusion.

In other embodiments, the (e.g. first) end plate includes a beam (e.g. a pin) which is fixed to the (first) end plate at a first anchor point and a second anchor point and extends over an opening in the (first) end plate, wherein the first length and second length are attached to, e.g. slid onto, the beam. In some embodiments the anchor points are opposite each other.

It will be understood that in all embodiments each plate comprises at least one opening. Each plate may comprise only one opening, or may comprise a plurality of openings. The one or more openings may be any suitable size, but are preferably sized to allow movement of the respective connecting elements through the one or more openings without contact occurring between the connecting element and the part of the plate defining the opening.

In some embodiments, the mooring component is arranged such that there is no (direct) contact between the first connecting element (and optionally any other connecting elements) and the first compressive element. Using connecting elements with no contact to the compressive element allows for flexible elements to be used as no resistance to lateral load is required. This is advantageous for the reasons as laid out above. Furthermore, in embodiments in which there is not contact between the connecting elements and their respective compressive elements, the need to use bearings or sliding elements to control the friction is also advantageously avoided. Instead the connecting elements are able to move freely relative to the compressive element, as the mooring component is compressed or expands, since there is no contact between the surfaces of the connecting element and the compressive element.

In some embodiments, the first end plate (optionally each end plate) comprises a substantially circular ring. Such a ring may advantageously help to distribute forces across the compressive elements. It will be understood that this only requires that the end plate includes a ring, but does not exclude the presence of additional components attached to, or formed with the ring e.g. protrusions, or a beam, as described above.

In some embodiments the first and second compressive elements (optionally all compressive elements in the series) are (substantially) identical, e.g. they are made of the same material, and have the same shape and dimensions. This helps to reduce the cost of the mooring system since only a single type (e.g. size/shape etc.) of compressive element is required to be manufactured e.g. the same mould can be reused. This advantageously helps the compressive elements to behave the same way under compression, giving a smooth and even response of the mooring system under tension.

In other embodiments, first and second compressive elements (optionally all compressive elements in the series) are different, e.g. having different shapes or material properties, such that they provide a different response under compression. The use of two different types of compressive elements can allow the response of the mooring system to be further tailored to provide a desired response, e.g. such that the (two) elements will be compressed by different amounts under the same amount of compression. This provides suitability for different sea states, due to the different responses of the compressive elements. For example, in an extreme case one element may compress fully, e.g. in light sea states, before the other even starts to compress, e.g. to respond to heavy sea states.

In some embodiments the first (and/or second) compressive element is formed from polymer. Polymer material can be formed into certain shapes which have particularly desirable stiffness responses under compression.

The first (and/or second) compressive element may be a three dimensional outer shape partially, substantially or fully surrounding a cavity (although components of the mooring component may then be present within the cavity). Thus, in some embodiments, the compressive element(s) may be hollow, i.e. define a hollow shape.

The first (and/or second) compressive element may be defined by a profile and/or width and/or radius which varies along a defined axis. In the present embodiments the profile/width/radius may vary along the central axis of the compressive element. In some embodiments the first (and/or second) compressive element comprises a single convolute. It will be understood that by this is meant that the shape of the compressive element is such as to extend to a single extreme extension e.g. outwards to a maximum or inwards to a minimum. For example, the compressive element may have a substantially circular (inner and/or outer) cross section with respect (i.e. perpendicular) to an element axis (which may be the central axis of the mooring component/system).

The diameter/radius of the compressive element, along this central axis may thus increase, to a particular maximum value, and then only decrease, giving a single peak (inner or outer) radius/diameter of the compressive element. Alternatively, the diameter/radius of the compressive element, along this central axis may thus decrease, from its size at each end of the compressive element (which may not be the same at each end), to a particular minimum value, and then only increase, giving a single minimum (inner or outer) radius/diameter of the compressive element. The shape (diameter and thickness) along the axis may thus be varied to achieve a particular desired response.

Furthermore, in contrast to a compressive element comprising multiple such convolutes, it has been appreciated that the use of only a single convolute in a mooring component still gives a desirable stiffness (i.e. stress-strain) response, but has improved stability and does not require any lateral stabilisation. Furthermore it has been appreciated that the ability to connect multiple such “single convolute” mooring components in series provides a mooring system in which it is much easier to optimise the choice of components for a specific location, or specification, than if a single, multi-convolute compressive element were used. The process is simplified, for example, since a large variety of responses can be achieved using only a small stock of designs of single-convolute elements, compared to re-designing a new multi-convolute design for each specific desired response.

In some embodiments the first (and/or second) compressive element may be arranged to compress up to at least 15% of the length of the mooring component, optionally at least 25%, further optionally up to 50%. In some embodiments the first (and/or second) compressive element is arranged such that when the compressive stress applied to the compressive element causes the compressive element to be compressed by a particular fraction of an uncompressed length of the compressive element, two portions of the compressive element are brought into mutual contact. This advantageously helps to change the stiffness response of the compressive element at the amount of compression at which contact occurs, so that the response of the compressive element becomes stiffer.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a cross-sectional view showing a mooring system according to a first embodiment of the present invention;

FIG. 2a is a cross-sectional view showing a slight variation of the mooring system of FIG. 1, in which the connecting elements are provided by rope, rather than chain;

FIG. 2b is a perspective cutaway view of the mooring system of FIG. 2a;

FIG. 2c is a perspective cutaway view of the mooring system of FIG. 2a, showing end connections which can connect the mooring system into a mooring line;

FIG. 2d is a perspective cutaway view showing a slight variation of the mooring system of FIG. 2c, including three rather than two mooring components;

FIG. 3 is a cross-sectional view showing a mooring system according to a second embodiment of the present invention;

FIG. 4 is a perspective side view of a mooring component according to a third embodiment of the present invention;

FIG. 5 is a perspective side view showing a connecting element of the mooring component of FIG. 4;

FIG. 6 is a cutaway view showing the connecting elements and end plates of the mooring component of FIG. 4;

FIG. 7 is a perspective view showing the mooring component of FIG. 4, from above;

FIG. 8 is a perspective cut-away side view, from slightly above, showing the mooring component of FIG. 4;

FIG. 9 is a perspective side view, from slightly below, showing a connecting element of the mooring component of FIG. 4;

FIG. 10 is a perspective side view of a mooring component according to a fourth embodiment of the present invention;

FIG. 11 is a perspective side view showing a connecting element and an end plate of the mooring component of FIG. 10;

FIG. 12 is a cutaway view showing the connecting elements and end plates of the mooring component of FIG. 10;

FIG. 13 is a perspective view showing the mooring component of FIG. 10, from above;

FIG. 14 is a perspective cut-away side view, from slightly above, showing the mooring component of FIG. 10;

FIG. 15 is a perspective side view, from slightly below, showing a connecting element of the mooring component of FIG. 10;

FIG. 16 is a perspective view, from above, of a mooring component according to a fifth embodiment of the present invention;

FIG. 17 is a cutaway side view showing a mooring component according to a sixth embodiment of the present invention;

FIG. 18 is a perspective view, from above, of a mooring component according to a seventh embodiment of the present invention;

FIG. 19 is a cutaway side view of a mooring component according to a eight embodiment of the present invention;

FIG. 20 is a perspective side view of a mooring component according to an ninth embodiment of the present invention;

FIG. 21 is a perspective side view showing a connecting element and an end plate of the mooring component of FIG. 20;

FIG. 22 is a cutaway view showing the connecting elements and end plates of the mooring component of FIG. 20;

FIG. 23 is a perspective view showing the mooring component of FIG. 20, from above;

FIG. 24 is a perspective cut-away side view showing the mooring component of FIG. 20;

FIG. 25 is a perspective cutaway view, from slightly below, showing a connecting element of the mooring component of FIG. 20; and

FIG. 26 is a side view of a mooring system comprising mooring components as shown in FIG. 20.

### DETAILED DESCRIPTION

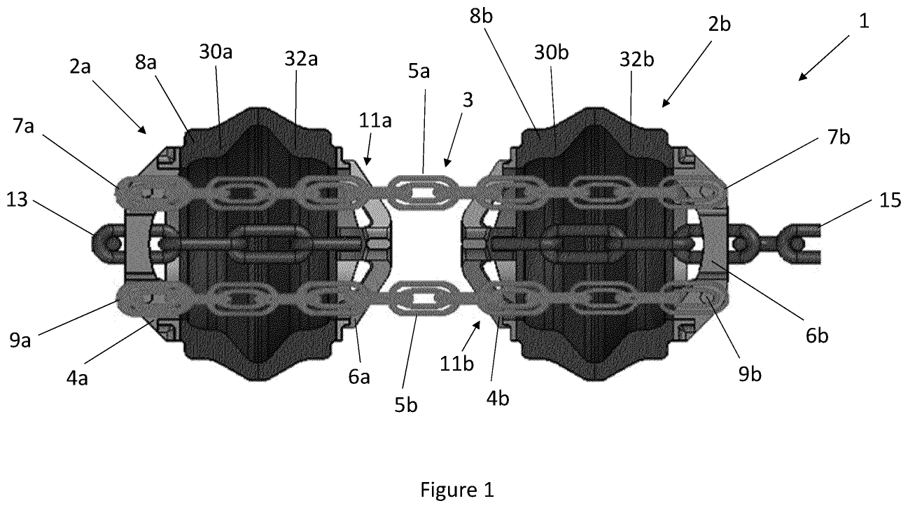

FIG. 1 is a cross-sectional view showing a mooring system 1 according to a first embodiment of the present invention. The mooring system 1 includes a first mooring component 2a and a second mooring component 2b. Each mooring component includes a respective pair of end plates with a compressive element arranged between them.

Thus, the first mooring component 2a includes a first end plate 4a and a second end plate 6a, and a compressive element 8a, connected between the first end plate 4a and the second end plate 6a. The second mooring component 2b includes a third end plate 4b, a fourth end plate 6b, a second compressive element 8b, connected between the third end plate 4b and the fourth end plate 6b.

The mooring system 1 further comprises a first connecting element 3, including a first length 5a, and a second length 5b which is separate to the first length 5a. The first length 5a and the second length 5b are entirely separate i.e. they do not meet or intersect within the mooring system 1 as shown in FIG. 1.

As can be seen in FIG. 1, the first length 5a of the first connecting element 3 is connected to the first end plate at a first position 7a, and is connected to the fourth end plate 6b at a second position 7b. The first length 5a passes through an opening 11a in the second end plate 6a and another opening 11b in the third end plate 4b.

Similarly, the separate second length 5b is connected to the first end plate 4a at a third position 9a and to the fourth end plate 6b at a fourth position 9b. The second length 5b passes through an opening 11a in the second end plate 6a and another opening 11b in the third end plate 4b. The first mooring component 2a and the second mooring component 2b are therefore connected in series.

The mooring system 1 as shown further includes a second connecting element 13, connected to the second end plate 6a. Although not shown in this side view, the second connecting element 13 comprises two separate lengths, each of which is connected to the second end plate 6a at a different position. Although not visible in FIG. 1, this second connecting element 13 is similar to the first connecting element 3, but is rotated by 90 degrees relative to the central axis of the mooring component (which is why the separate lengths of the second connecting element 13 are not visible in FIG. 1).

There is similarly a third connecting element 15, comprising two separate lengths (not visible in FIG. 1), connected to the third end plate 4b, each at a different position. Whilst described as “separate” lengths within the mooring system, the lengths of the second connecting element 13 and/or the third connecting element might meet outside of this mooring system e.g. further to the right or left than is shown in FIG. 1.

As a result of this arrangement, tension applied to the second connecting element 13 and the third connecting element 15 will try to move the second end plate 6a and the third end plate 4b respectively away from each other, but tension in the first and second lengths 5a, 5b of the first connecting element 3 will prevent the first end plate 4a from moving respectively away from the fourth end plate 6b, so that the second and third plates 6a, 4b, must move relative to their respective corresponding plates 4a, 6b. As a result both the first compressive element 8a and the second compressive element 8b are compressed.

The compressive elements 8a, 8b may, for example, be polymer springs, or “convolutes”. As shown they may be a single “convolute” e.g. a substantially circular shape having a single maximum diameter. Variations in both the shape and the material properties of these compressive elements can be used to vary the force response which they produce under compression, to give a mooring component having a desired response where tension is applied to the first and third connecting elements 13, 15.

As seen in the cross-sectional view of FIG. 1, each compressive element has a varying cross-sectional shape (with respect to the plane of cross-section of FIG. 1), including a respective pair of inner shoulders 30, 32. The compressive elements are arranged such that when the compressive stress applied to the compressive element causes the compressive element to be compressed by a particular fraction of an uncompressed length of the compressive element (e.g. 50% or more), the two inner shoulders 30a, 32a (and/or 30b, 32b) of the compressive element 8a, 8b are brought into mutual contact. This contact causes the compressive element 8a, 8b to provide a much stiffer response once compressed any further than this point. This is desirable in order to ensure that the mooring component 1 is able to endure very high tension forces, as might arise in a particularly rough sea state.

The connecting elements 3, 13, 15 in this example are made of chain e.g. standard marine mooring chain. This is advantageous since it is freely available, but it is also flexible which allows the mooring system 1 to flex or bend along its length, giving a more versatile and desirable response. For example, the mooring system 1 may be connected at either end (e.g. by the second and third connecting elements 13, 15) to mooring lines, ropes or chains. When such mooring lines, ropes or chains change shape e.g. due to an increase in force, such that the overall line becomes more or less curved/bent, it is desirable that the mooring system as shown in FIG. 1 can also change shape in the same way. This is achieved by the illustrated arrangement of FIG. 1.

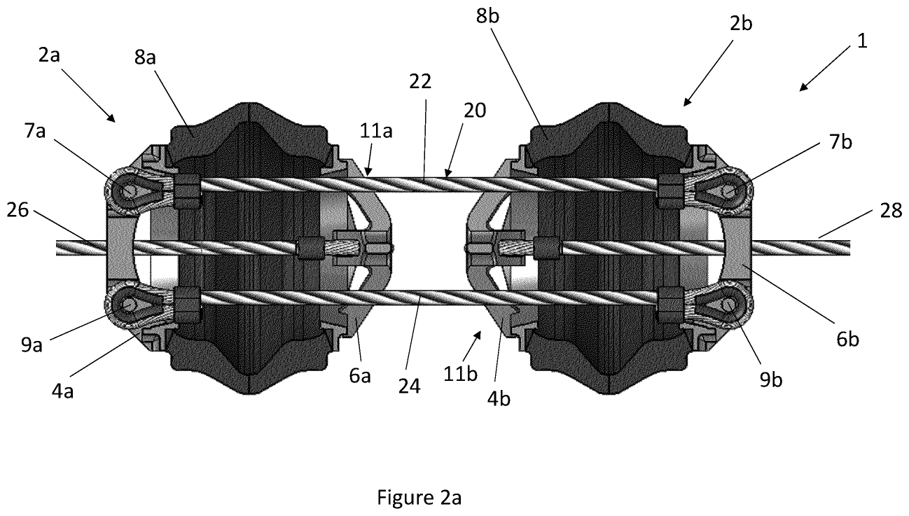

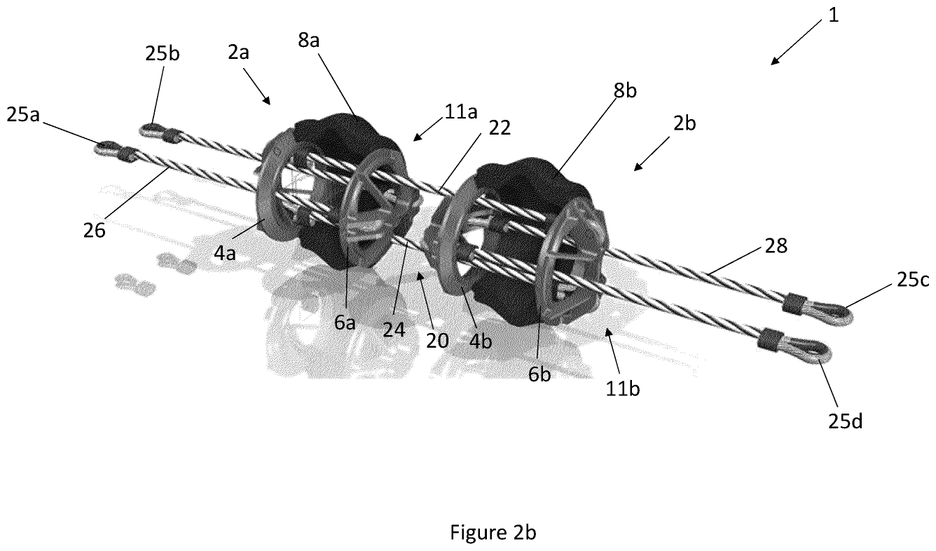

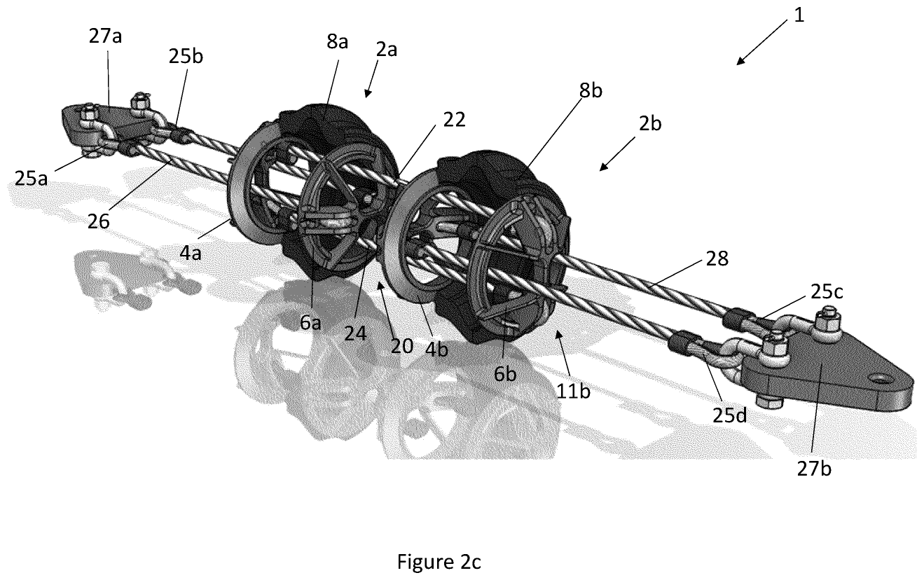

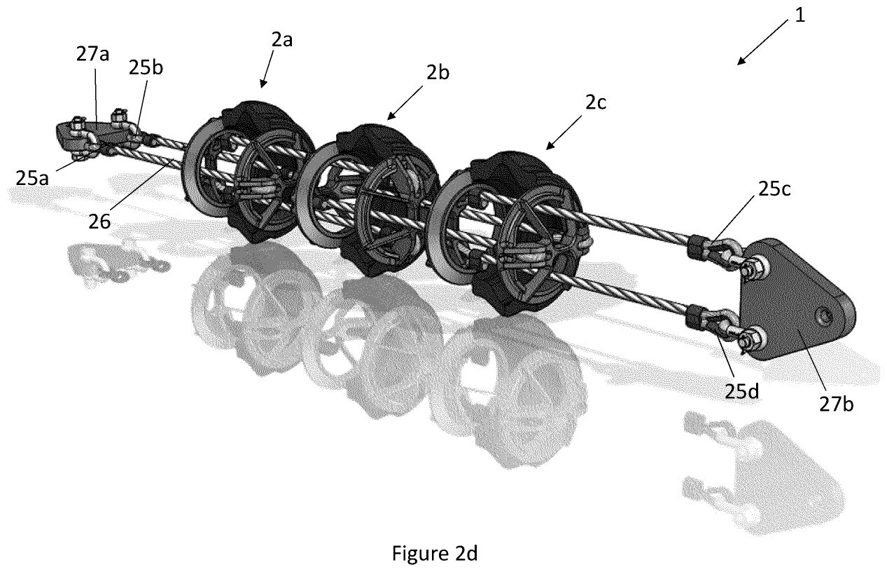

The connecting elements might alternatively be made of fibre or wire rope, rather than chain, as shown in FIGS. 2a-2d. Like elements have been labelled with the same reference numerals as in FIG. 1, since the mooring systems are the same other than the change in material of the connecting elements. The first connecting element is now a first rope connecting element 20, including a first length 22, and a second length 24 which is separate to the first length 22. The mooring system 1 as shown further includes a second rope connecting element 26, and a third rope connecting element 28, in place of the corresponding chain lengths in the mooring system of FIG. 1.

FIG. 2b is a perspective cutaway view of the mooring system of FIG. 1b, where the front sections of the compressive element are cutaway so that the connecting elements 20, 26, 28 are visible passing through them. It can be seen that the distal ends (i.e. the ends further from the mooring components) of the lengths of the second and third rope connecting elements 26, 28 include connection portions 25a-d. As seen in FIG. 2c, these respective connection portions may be connected to connection plates 27a, 27b, which then provide a single connection point to which a mooring line or chain might be connected.

FIG. 2d shows a slight variation of the mooring system of FIG. 2c, which including three mooring components 2a, 2b, 2c, rather than two as shown in FIG. 2c. It can be seen that because an odd number of mooring components is present, the connection plates 27a, 27b, connected to either end of the mooring system are at right angles to each other (along the central axis).

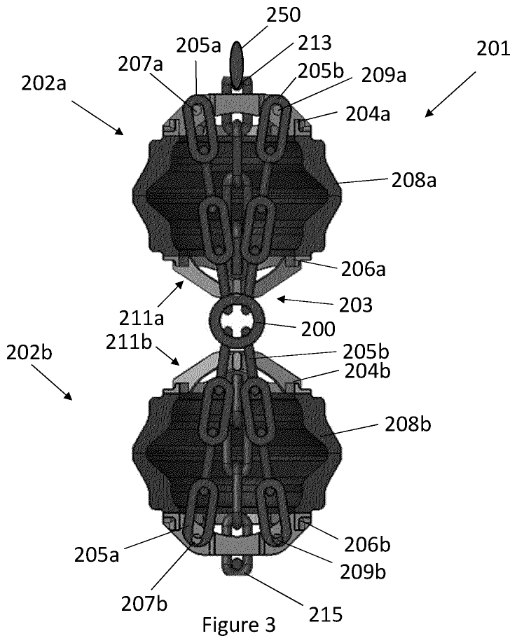

FIG. 3 is a cross-sectional view showing a mooring system according to a second embodiment of the present invention. This embodiment has many features in common with the embodiment of FIG. 1, and therefore like reference numerals have been used throughout, with their value increased by “200”, compared to the reference numerals of FIG. 1, to denote that they relate to the second embodiment.

The mooring system 201 includes a first mooring component 202a and a second mooring component 202b. The first mooring component 202a includes a first end plate 204a and a second end plate 206a, and a compressive element 208a, connected between the first end plate 204a and the second end plate 206a. The second mooring component 202b similarly includes a third end plate 204b, a fourth end plate 206b, a second compressive element 208b, connected between the third end plate 204b and the fourth end plate 206b.

The mooring system 201 further comprises a first connecting element 203. As with the embodiment of FIG. 1, the first connecting element 203 includes a first length 205a, and a second length 205b. The difference compared to the first embodiment is that the first length 205a and the second length 205b are not separate lengths, but are joined at a ring 200 which is part of both the first length 205a and the second length 205b, giving a first connecting element 203 which is substantially X-shaped. In this example the ring 200 i.e. the intersection point of the first and second lengths, is located outside of both of the compressive elements 208a, 208b, between the two mooring components 202a, 202b.

As in the embodiment of FIG. 1, the first length 205a is connected to the first end plate 204a at a first position 207a, and is connected to the fourth end plate 206b at a second position 207b. The connection points are provided by pins that pass through respective chain links in the first length 205a and the second length 205b. Similarly, the second length 205b is connected to the first end plate 204a at a third position 209a and to the fourth end plate 206b at a fourth position 209b.

The first length 205a and the second length 205b pass through an opening 211a in the second end plate 206a and another opening 211b in the third end plate 204b.

The mooring system 201 again further includes a second connecting element 213 and a third connecting element 215, connected respectively to the second and third end plates 206a, 204b. Although not shown in this side view, these other connecting element comprises two separate lengths, each of which is connected to the end plates at a different position. The plane of these lengths is perpendicular to the plane of the page of FIG. 3, as discussed below.

The operation of the mooring system 201 under tension of the second and third connecting elements, as well as the properties of the compressive elements (and of the material properties of the connecting elements) are as described above with reference to FIG. 1. This is also the case for all embodiments described herein below, other than where specific differences from this first embodiment are identified and described.

The second connecting element 213 also comprises a ring 250 at which the two lengths of the second connecting element 213 meet. Thus the first and second position, and the connection at ring 200 define a plane of the first connecting element 203 i.e. the plane of the page. Similarly, the two connection points of the second connecting element 213 to the second end plate 206a (not visible in FIG. 3) and their connection at the other ring 250, define a second plane, of the second connecting element (i.e. into the page, a plane which is perpendicular to the plane of the page).

The arrangement of these connecting elements with mutually perpendicular planes provides a connection mechanism for the mooring system 201 which is very stable under twisting forces and also tension forces.

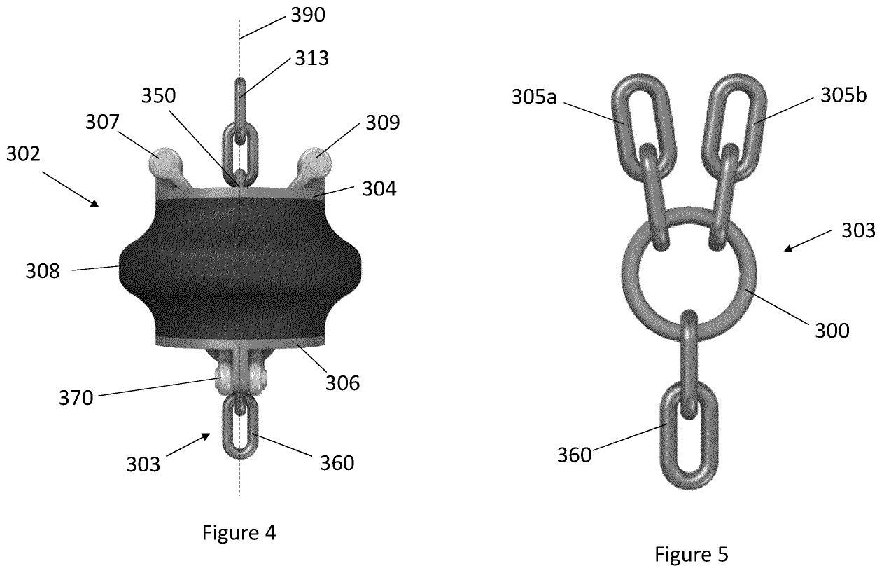

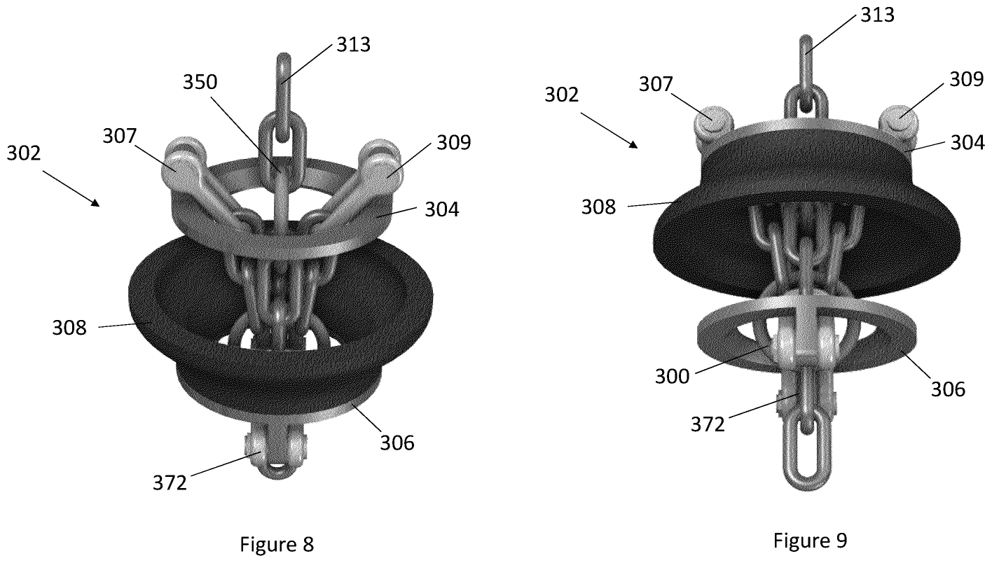

FIGS. 4-9 show a mooring component according to a third embodiment of the present invention. Here like reference numerals are again used for like components, but with their value increased by 300 (compared to FIG. 1) to denote that they relate to the third embodiment. Since in this embodiment only a single mooring component 302 is described, the suffixes “a” and “b” will not be used.

The mooring component 302 includes a first end plate 304 and a second end plate 306, and a compressive element 308, connected between the first end plate 304 and the second end plate 306.

A first connecting element 303 again comprises a first length 305a and a second length 305b (seen more clearly in FIG. 5, which shows only the first connecting element 303). The first length 305a is connected to the first end plate 304 at a first position 307, and the second length 305b is connected to the first end plate 304 at a second position 309.

As in the embodiment of FIG. 2, the first length 305a and the second length 305b meet at a ring 300. In this embodiment the first connecting element also comprises a common length or portion 360 (in this example a length of chain), which can be considered to belong to both the first length and the second length. This gives a first connecting element which is substantially Y-shaped, as seen in FIG. 5.

Where a mooring system is created by attaching multiple of these mooring components 302 together, a further ring (or two additional lengths directly) may be attached to common length 360, and then go on to connect to a further end plate of an adjacent mooring component, to form an overall X-shaped first connecting element (albeit the intersection point of the “X” may be an extended common length 360).

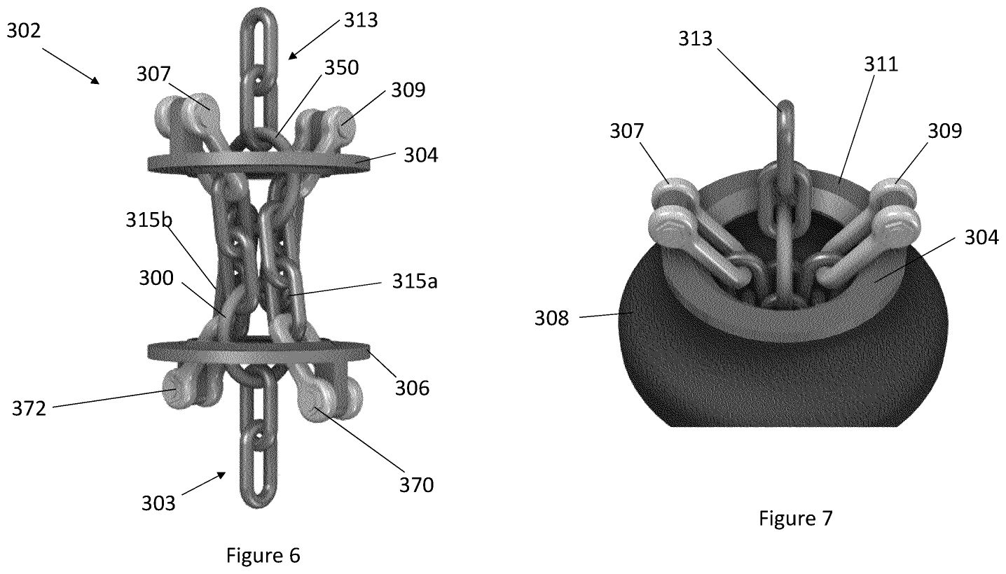

There is also a second connecting element 313 arranged within the compressive element 308 of the mooring component 302, which can be seen more clearly in FIG. 6, which is a cutaway view showing only the first and second end plates 304, 306, and the first and second connecting elements 303, 313.

It can be seen that second connecting element 313 also comprises a first length 315a and a second length 315b, which are joined at a ring 350. The first length 315a of the second connecting element 313 is connected at a third position 370 to the second end plate 306, and the second length 315b is connected to the second end plate 306 at a fourth position 372. The second connecting element 313 can be seen in FIG. 7, protruding through an opening 311 in the first end plate 304.

Thus, the first position 307, second position 309, and intersection point at the ring 300 define a plane of the first connecting element 303. Similarly, the third position 370, the fourth position 372, and the intersection of the first and second lengths 315a, 315b at the ring 350 define a plane of the second connecting element 313. Similar to the embodiment of FIG. 3, these planes are perpendicular.

The rings 300, 350 are arranged so that each ring (and therefore each intersection point) is position on a central, elongate axis of symmetry of the mooring component e.g. central with respect to the end plates and/or the compressive element. This central axis 390 is shown in FIG. 4. Furthermore, the rings 300, 350 are arranged so that the ring 300 of the first connecting element is below (i.e. closer to the second end plate 306) than the ring 350 of the second connecting element. This results in an arrangement in which the first connecting element 303 and the second connecting element 313 are interleaved i.e. the Y-shapes of each element are inverted with respect to each other, and the open portions of the Y-shaped are overlapped with respect to the central axis 390 of the mooring component. In this example the first and second connecting elements 303, 313, are arranged so that the intersection points i.e. rings 300, 350 are located within the compressive element 308.

It is seen (e.g. in FIG. 7) that the connections to the first end plate 304 at the first position 307 and the second position 309 are provided by shackles. These are easily available and can be easily fastened and unfastened as required, with minimal effort. Similarly the connections to the second end plate 306 at the third position 370 and the fourth position 372 are also provided by shackles, as seen in FIG. 6.

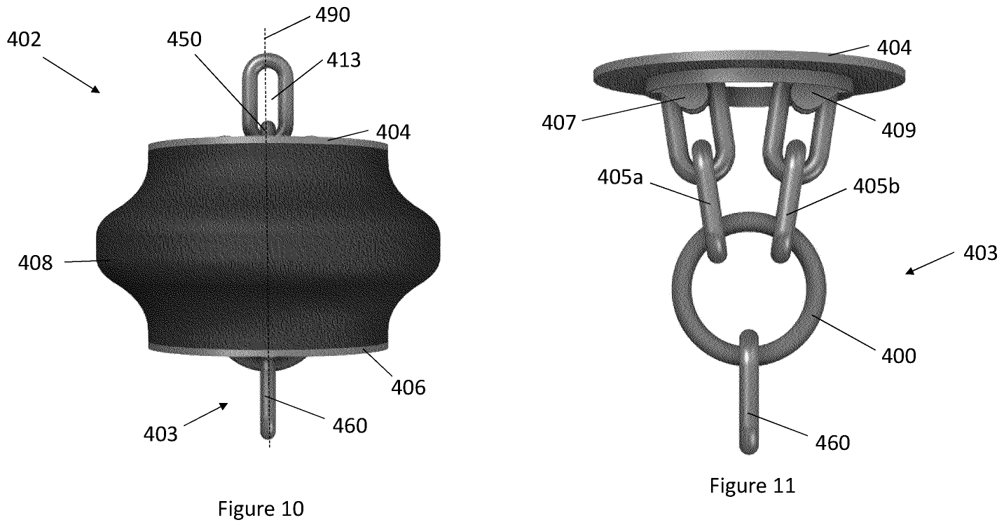

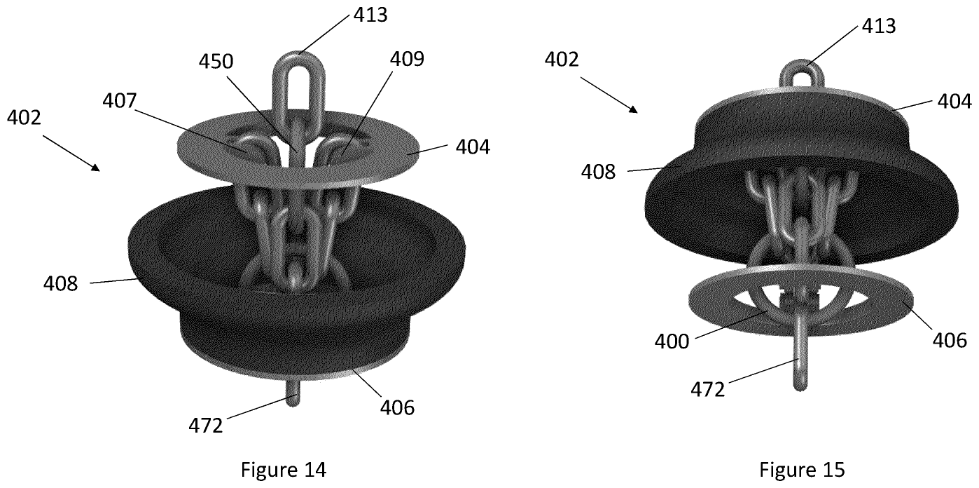

FIGS. 10-15 show a mooring component 402 according to a fourth embodiment of the present invention.

This embodiment is very similar to the third embodiment described above, and therefore the description below will focus only on the differences, which relate to the end plate designs and specifically to how the connecting elements connect to the end plates. Like reference numerals will be used, based on those used in FIGS. 4-9, but prefixed by a “4”, denoting the fourth embodiment, rather than a “3”.

The mooring component 402 includes a first end plate 404 and a second end plate 406, and a compressive element 408, connected between them. The first connecting element 403 (seen in FIG. 11) again comprises a first length 405a and a second length 405b. The first length 405a is connected to the first end plate 404 at a first position 407 (e.g. seen in FIGS. 11 and 13), and the second length 405b is connected to the first end plate 404 at a second position 409.

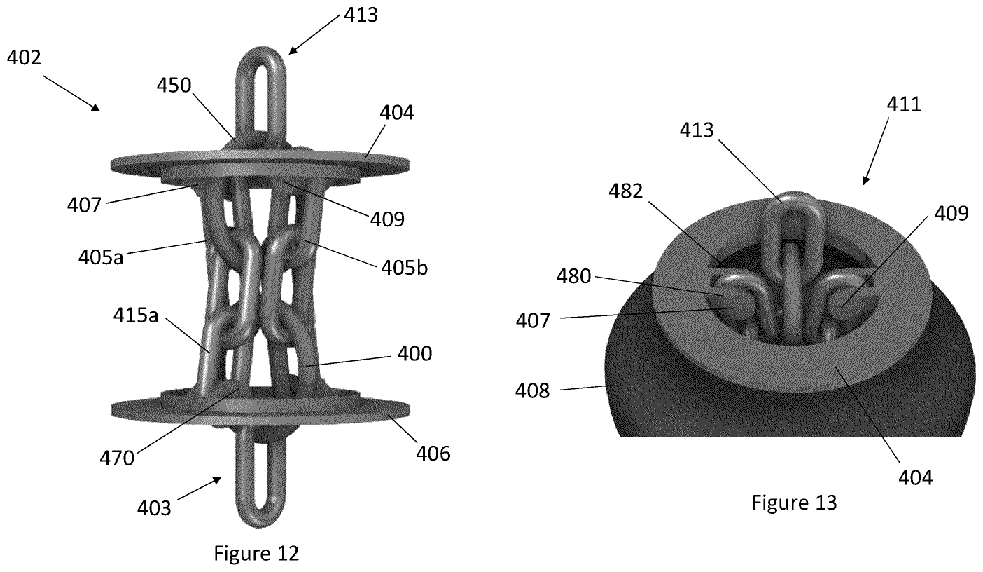

As in the embodiment of FIG. 4, the first length 405a and the second length 405b meet at a ring 400, and the first connecting element 403 also comprises a common length or portion 460. There is also a second connecting element 413 arranged (at least partially) within the compressive element 408 of the mooring component 402, which can be seen more clearly in FIG. 12, which is a cutaway view showing only the first and second end plates 404, 406, and the first and second connecting elements 403, 413.

It can be seen that second connecting element 413 also comprises a first length 415a and a second length 415b, which are joined at a ring 450. The first length 415a of the second connecting element 413 is connected at a third position 470 to the second end plate 406, and the second length 415b is connected to the second end plate 406 at a fourth position 472. The second connecting element 413 can be seen in FIG. 13, protruding through an opening 411 in the first end plate 404.

The difference of the fourth embodiment compared to the connecting element 302 described above is in how the connection to the two end plates is achieved. In this embodiment, the first end plate 404 (and also the second end plate 406, although this is not as clearly visible) comprise an opening 411, defining an inner circumference, and there are protrusions from this inner circumference (as seen in FIG. 13) which provide the first and second positions 407, 409.

In this example each protrusion comprises a first protrusion portion 480 and a second protrusion portion 482, defining a gap therebetween into which the first and second length, respectively, are inserted in order to form a connection with the first end plate 404 e.g. by fixing a pin between the two protrusion portions 480, 482, where the pin also passes through the first/second length e.g. through a link of a chain. This arrangement can be referred to as an “H-link”, due to the “H” shape formed by the first and second protrusion portions and the pin passing between them.

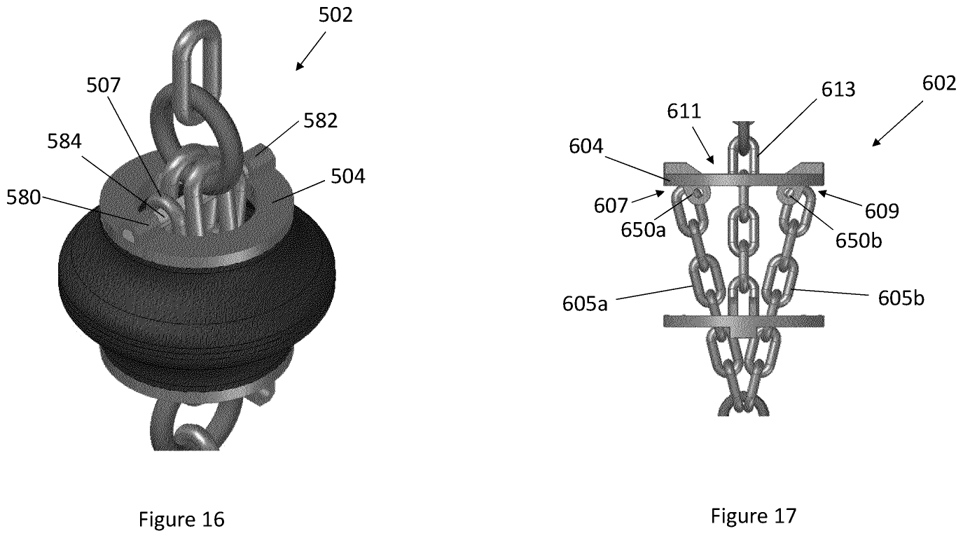

Many other means can be used to provide the connections at the first and second positions. Two further alternative examples are illustrated in the fifth embodiment, shown in FIG. 16 and the sixth embodiment, shown in FIG. 17.

In this mooring component 502, the first end plate 504 includes a beam 584 which is fixed to the first end plate 504 at a first anchor point 580 and a second anchor point 582. In this example the anchor points are opposite each other. The beam 584 extends over an opening 511 in the first end plate 504. The first length and second length can be attached to e.g. slid onto, the beam, e.g. before it is fixed to the anchor points, thereby creating the first position 507 and the second position (not visible) at which the first and second lengths are respectively fastened to the first end plate 504.

Another alternative connection means is seen in FIG. 17, in which the connection points 607, 609 of the mooring component 602 are provided by projections 650a, 650b which protrude from the surface of the first end plate 604. Both projections 650a, 650b extend from an upper surface of the first end plate 604 through an opening 611, to within the compressive element (not shown). In this example the projections 650a, 650b are opposite each other, i.e. on opposite sides of the end plate 604.

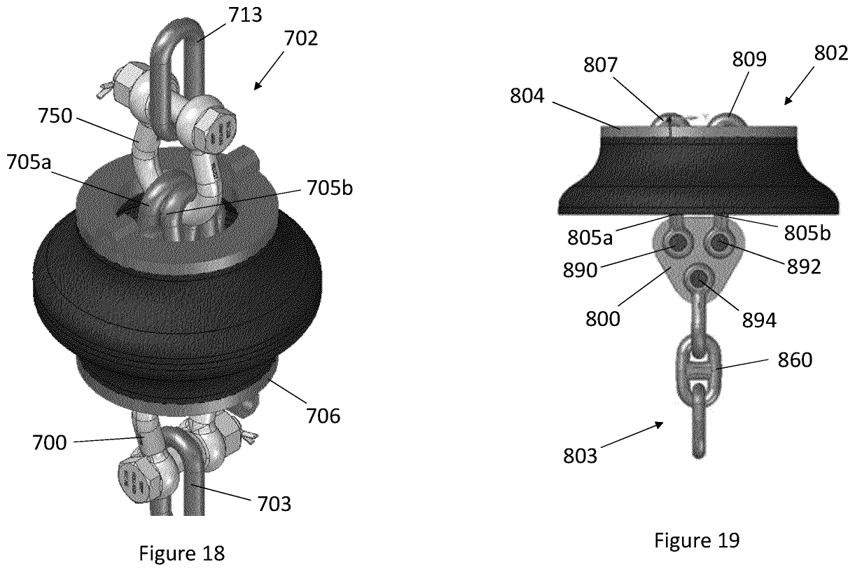

In the second, third, fourth and sixth embodiments, the first length and the second length are connected at an intersection point which is provided by a ring. There are many suitable alternatives which can be used in place of this ring. Two possible alternative examples are shown respectively in the seventh embodiment, shown in FIG. 18, and in the eighth embodiment, shown in FIG. 19.

FIG. 18 is a perspective view, from above, of a mooring component 702 according to a seventh embodiment of the present invention. It can be seen that in this embodiment, the first length 715a and the second length 715b of the second connecting element 713 intersect (i.e. at connected) at a shackle 750. This is convenient as it can be easily fastened and unfastened. Although the first and second lengths of the first connecting element 703 are not visible, the shackle 700 at which they similarly interconnect is visible in FIG. 18, below the second plate 706.

FIG. 19 is a cutaway side view of a mooring component 802 according to a eighth embodiment of the present invention, showing a further possible variation. In this example, the first length 805a and the second length 805b of the first connecting element 803 are connected to the first end plate 804 at respective first and second connection points 807, 809. The first length 805a and the second length 805b are then each connected to separate connection points 890, 892 on a metal plate 800. The third connection point 894 of the metal plate is then connected to a common length 860, which is also part of the first connecting element 803, and can be considered to belong to both the first length and the second length. In this embodiment, the metal plate is provided by a tri-plate (a triangular plate) which is a standard metal mooring component.

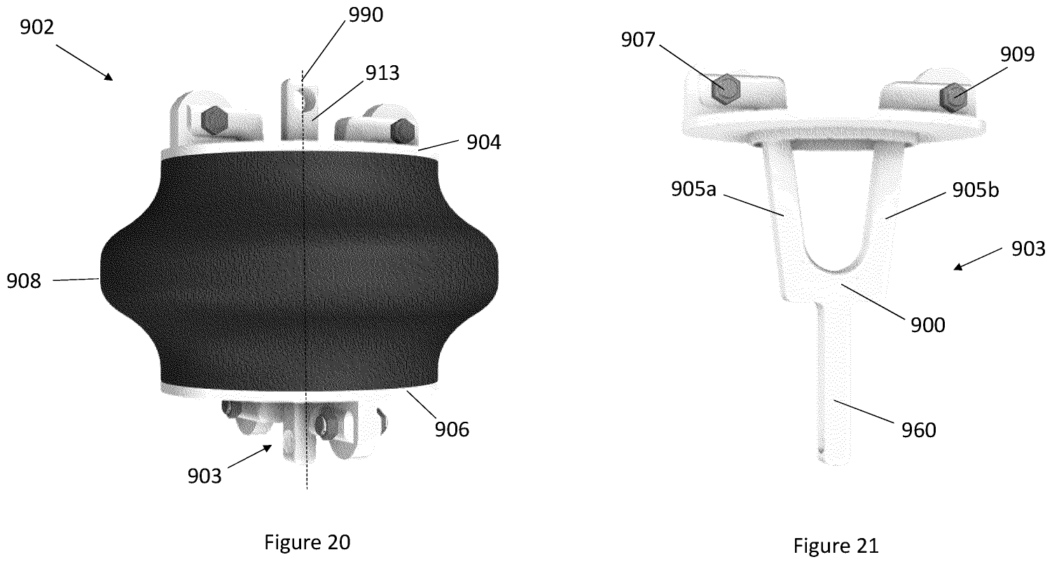

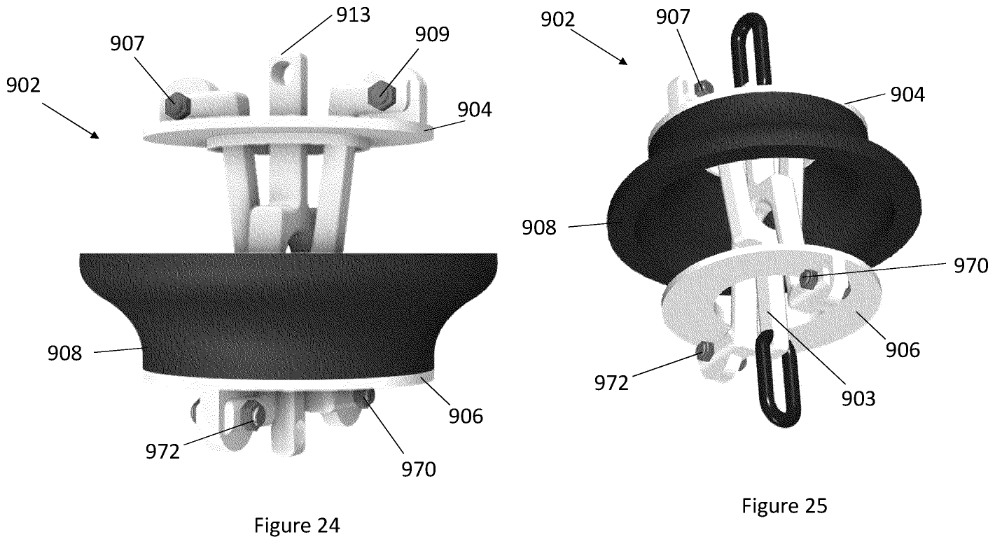

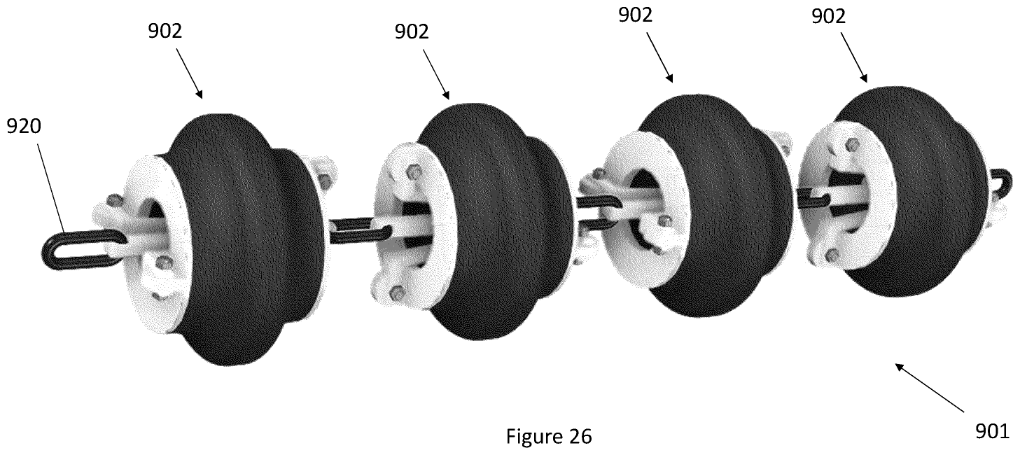

All of the embodiments described previously have included flexible connecting elements, which provides certain advantages as described above. However, an advantageous mooring component and system can also be achieved using rigid connecting elements, as demonstrated by the ninth embodiment, shown in FIGS. 20-25. FIG. 26 shows a mooring system formed by connecting together a series of mooring components according to the ninth embodiment of the present invention.

The mooring component 902 includes a first end plate 904 and a second end plate 906, and a compressive element 908, connected between the first end plate 904 and the second end plate 906. A first connecting element 903 and a second connecting element 913 are arranged within the compressive element 908 of the mooring component 902. The mooring component 902 has a central axis of symmetry 990 as shown in FIG. 20.

The first connecting element 903 of the mooring component 902 is shown in more detail in FIG. 21. The first connecting element 903 is a single, rigid component, which is substantially Y-shaped. It comprises a first length 905a and a second length 905b, which come together at an intersection point 900, and further comprises an additional (or common) length 960, extending downwards (in the view of FIG. 21 i.e. away from) the intersection point 900.

The first length 905a is connected to the first end plate 904 at a first position 907, and the second length 905b is connected to the first end plate 904 at a second position 909.

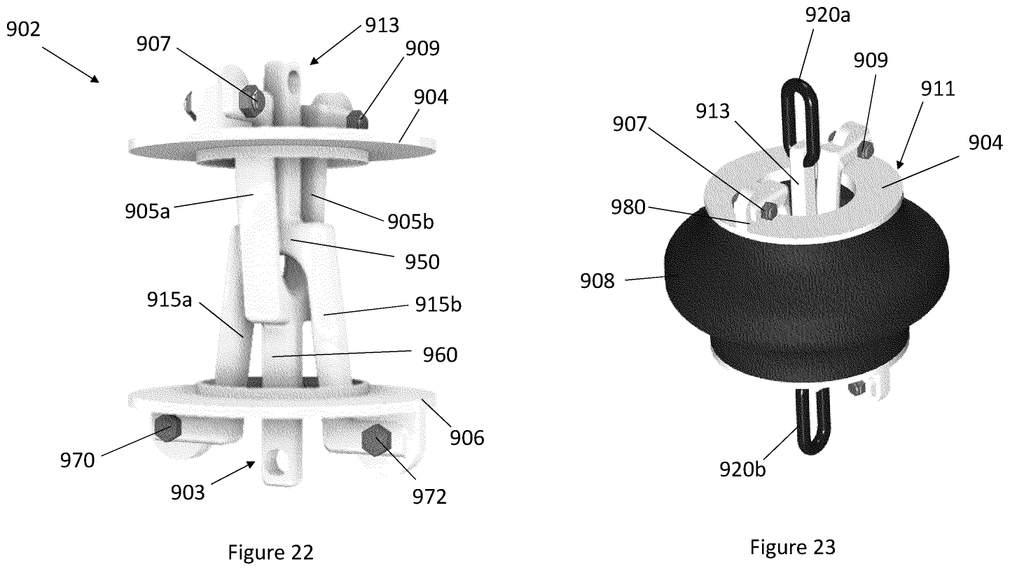

As seen in FIG. 22, the second connecting element 913 has the same construction as the first connecting element 903, comprising a first length 915a and a second length 915b, which come together at an intersection point 950, and an additional length. The first length 915a is connected to the second end plate 906 at a first position 970, and the second length 915b is connected to the first end plate 904 at a second position 909.

Since both of the connecting elements 903, 913 are rigid, as are the end plates 904, 906, at least one of these components (e.g. at least one of the end plates or connecting elements) must be sub-divided in order to allow the structure seen in FIG. 22 to be assembled.

The connections at the first and second positions 907, 909 can be seen in more detail in FIG. 23. Each position is provided by a protrusion 980 which extends from the upper surface of the first end plate 904, the upper surface being the opposite surface to the surface which contacts the compressive element 908. In this example, the first connecting element 903 is formed so that each of the first and second lengths includes an end portion which is complementary with i.e. matches, mates with, the protrusion 980, to facilitate easy connection. As laid out above, many other alternative connection arrangements are possible e.g. an H-link, which can also be used to facilitate easy connection.

The mooring component 902 can further include additional links 920a, 920b, connected to the rigid structure of the first/second connecting elements to allow additional such mooring components, or a mooring line etc. to be connected to the mooring component 902. The links 920a, 920b could alternatively be replaced by a shackle or any other suitable connecting mechanism. A mooring system 901 resulting from connecting a series of such mooring components 902 together is shown in FIG. 26.

It will be appreciated by those skilled in the art that the invention has been illustrated by describing one or more specific embodiments thereof, but is not limited to these embodiments; many variations and modifications are possible, within the scope of the accompanying claims.

1. A mooring system, comprising:
a first mooring component, the first mooring component comprising:
a first end plate;
a second end plate; and
a first compressive element, connected between the first end plate and the second end plate;
a second mooring component, the second mooring component comprising:
a third end plate;
a fourth end plate; and
a second compressive element, connected between the third end plate and the fourth end plate; and
a flexible connecting element, comprising a first length, connected to the first end plate at a first position, and to the fourth end plate at a second position, and passing through openings in the second end plate and the third end plate, and comprising a second length, connected to the first end plate at a third position, and to the fourth end plate at a fourth position, and passing through openings in the second end plate and the third end plate, such that the first mooring component and the second mooring component are connected in series.

2. The mooring system of claim 1, wherein the first length and the second length meet at a first intersection point.

3. The mooring system of claim 2, wherein the first position, the second position, and the first intersection point define a first plane,
the mooring system further comprising a second flexible connecting element, comprising a third length, connected to the second end plate at a fifth position, and a fourth length, connected to the second end plate at a sixth position, wherein the third length and the fourth length meet at a second intersection point, such that the fifth position, the sixth position and the second intersection point define a second plane;
wherein the mooring component is arranged such that actuation of the first flexible connecting element and the second flexible connecting element, respectively away from each other, results in compression of the first compressive element.

4. The mooring system of claim 3, wherein the first plane and the second plane are non-parallel.

5. A mooring component, comprising:
a first end plate comprising an opening;
a second end plate comprising an opening;
a compressive element, connected between the first end plate and the second end plate;
a first connecting element, which passes through the opening in the second end plate, wherein the first connecting element comprises a first length, connected to the first end plate at a first position, and a second length, connected to the first end plate at a second position, the first length and the second length meeting at a first intersection point, such that the first position, the second position and the first intersection point define a first plane; and
a second connecting element which passes through the opening in the first end plate, wherein the second connecting element comprises a third length, connected to the second end plate at a third position, and a fourth length, connected to the second end plate at a fourth position, the third length and the fourth length meeting at a second intersection point, such that the third position, the fourth position and the second intersection point define a second plane;
wherein the first plane and the second plane are non-parallel; and
wherein the mooring component is arranged such that actuation of the first connecting element and the second connecting element, respectively away from each other, results in compression of the compressive element.

6. The mooring component of claim 5, wherein the first intersection point is closer than the second intersection point to the second end plate.

7. The mooring component of claim 5, wherein the line of intersection of the first plane and the second plane is coincident with a central axis of the mooring component.

8. The mooring component of claim 5, wherein the first plane and the second plane are mutually perpendicular.

9. The mooring component of claim 5, wherein the first length and the second length comprise at least one ring or link, in common between the first length and the second length.

10. A mooring system comprising at least two mooring components as claimed in claim 5, wherein the mooring components are connected in series.

11. (canceled)

12. A mooring system, comprising:
a first mooring component, the first mooring component comprising:
a first end plate;
a second end plate; and
a first compressive element, connected between the first end plate and the second end plate;
a second mooring component, the second mooring component comprising:
a third end plate;
a fourth end plate; and
a second compressive element, connected between the third end plate and the fourth end plate; and
a first connecting element, comprising a first length, connected to the first end plate at a first position, and to the fourth end plate at a second position, and passing through openings in the second end plate and the third end plate, and the first connecting element comprising a separate second length, connected to the first end plate at a third position, and to the fourth end plate at a fourth position, and passing through openings in the second end plate and the third end plate, such that the first mooring component and the second mooring component are connected in series.

13. The of mooring component of claim 5, wherein the first connecting element comprises at least one chain link or at least one ring.

14. (canceled)

15. The mooring component of claim 5, further comprising a triangular plate connected to the first connecting element, wherein the triangular plate comprises three connection points.

16. (canceled)

17. The of mooring component of claim 5, wherein the first end plate includes a beam which is fixed to the first end plate at a first anchor point and a second anchor point and extends over an opening in the first end plate, wherein the first length and second length are attached to the beam.

18. The mooring component of claim 5, wherein the first end plate comprises a substantially circular ring.

19. The mooring component of claim 5, wherein the first compressive element is formed from polymer.

20. The mooring component of claim 5, wherein the first compressive element comprises a single convolute.

21. The mooring component of claim 5, wherein the first connecting element and the first compressive element are arranged such that there is no direct contact between the first connecting element and the first compressive element.

22. (canceled)

23. The mooring component of claim 5, wherein the first connecting element is rigid and Y-shaped.

24. (canceled)

25. The mooring component of claim 5, wherein the first connecting element is flexible.
